(19) United States
(12) Patent Application Publication
(10) Pub. No.: US 2014/0103116 A1
(43) Pub. Date: Apr. 17, 2014

(54) RFID TAG ASSEMBLY AND LABEL PROCESS

(71) Applicants: Philippe Martin, Beaune (FR); David Derrien, Marseille (FR); Didier Elbaz, Marseille (FR); Francois Combes, Marseille (FR)

(72) Inventors: Philippe Martin, Beaune (FR); David Derrien, Marseille (FR); Didier Elbaz, Marseille (FR); Francois Combes, Marseille (FR)

(73) Assignee: TAGSYS SAS, LaCiotat (FR)

(21) Appl. No.: 14/007,058

(22) PCT Filed: Mar. 23, 2012
(86) PCT No.: PCT/AU12/00305

§ 371 Date: Dec. 5, 2013

(30) Foreign Application Priority Data
Mar. 24, 2011 (AU) 2011901095
Dec. 16, 2011 (AU) 2011905261

(51) Int. Cl. G06K 19/077

(52) U.S. Cl. CPC G06K 19/0776; G06K 19/07794
USPC 235/488; 235/492; 29/601

(57) ABSTRACT

A tag assembly is disclosed for attaching an RFID tag including a primary antenna to a flexible surface such as fabric, textile or an item of clothing. The tag assembly has a receptacle including a frame for securely holding the RFID tag, a secondary antenna, and attachment means for attaching the frame to the surface, wherein the frame forms part of the secondary antenna. A method of attaching an RFID tag to a flexible surface is also disclosed.

### CROSS REFERENCE TO RELATED APPLICATION

The present invention is a national phase entry under 35 U.S.C. §371 of International Application PCT/AU2012/000305, filed Mar. 23, 2012, which claims priority to AU 2011901095, filed Mar. 24, 2011, and AU 2011905261, filed Dec. 16, 2011, and is related to International Application no. PCT/AU2010/000373, filed Apr. 1, 2010, assigned to the present Applicant, all of which are incorporated herein by reference.

### TECHNICAL FIELD

The present invention relates to a tag assembly for attaching an RFID tag to a surface including a flexible surface such as textile or fabric and a process for producing an RFID label.

### BACKGROUND OF THE INVENTION

Use of a generic RFID tag on a flexible surface such as textile or fabric typically involves stitching or bonding the tag directly to the fabric or enclosing it within a patch to provide an enclosure for the tag. However this often leads to cumbersome and inflexible solutions particularly with a clothing garment that may be uncomfortable to wear.

In one prior art solution, a conductive thread is used to provide a secondary antenna and a plastics encapsulated RFID tag in the form of a traditional clothing button is stitched to the fabric in order to couple to the secondary antenna to form a larger overall tag system. While this solution is flexible and comfortable the thread link holding the button to the fabric loosens over time with repeated washing cycles and the button can rock about or tilt, deteriorating electromagnetic coupling between a primary antenna on the RFID tag and the secondary antenna associated the fabric.

One of the objects of the present invention is to at least alleviate the disadvantages of the prior art.

### SUMMARY OF THE INVENTION

The present invention may provide a two part tag solution, namely an RFID tag such as AK module or QFP package including an associated or primary antenna and means for attaching the tag to a surface such as fabric or cardboard. In some embodiments the primary antenna may couple to a secondary antenna provided on or with the surface. This solution may be particularly useful since use of ultra high frequency (UHF) as a carrier frequency for RFID tags has become more widespread following introduction of international UHF RFID standards. Although RFID protocols have converged, allowed regional UHF carrier frequencies have not. A separate secondary antenna may be useful for longer range operation because it may allow itself and thus the overall tag assembly, to be optimised for an operating region, using a common and economically manufacturable generic tag such as an AK module/QFP package which may account for most of the total cost.

The present invention may address problems of the prior art by providing a tag assembly including a receptacle or casing for receiving the RFID tag to replace the unstable button. The receptacle or casing may hold the RFID tag firmly in place to maintain a relatively consistent electromagnetic coupling between the primary antenna associated with the RFID tag and a secondary antenna associated with a flexible surface such as textile or fabric. The coupling may be substantially maintained throughout many washing cycles of service life of a fabric item.

According to one aspect of the present invention there is provided a tag assembly for attaching an RFID tag including a primary antenna to a surface, said assembly having a receptacle including a frame for securely holding the RFID tag, a secondary antenna, and attachment means for attaching the frame to said surface wherein said frame forms part of said secondary antenna.

The secondary antenna may include a dipole antenna. The surface may be flexible such as fabric or textile or it may be relatively rigid such as cardboard. The surface may include an item of clothing.

The RFID tag may include a separately formed adaptive kernel (AK) module (UHF tag) manufactured by Tagsys SAS. The AK module may be conveniently encapsulated via plastics molded packaging in any suitable manner and by any suitable means. In preferred embodiments the packaging for the AK module may include a quad flat package (QFP), a thin quad flat package (TQFP) or a low profile QFP package (LQFP).

The frame may be formed with a plurality of like frames by die stamping from a continuous roll of a conductive material. The conductive material preferably includes a relatively rigid and resilient material such as stainless steel.

The attachment means may include a plurality of legs or barbs connected to the frame. The free end of each leg or barb may include a sharpened lead to penetrate a surface such as textile or fabric and/or an eyelet or eyelets for receiving stitches. The tag assembly may include a backing plate for receiving the legs or barbs. The backing plate may include apertures to accommodate the legs or barbs.

The attachment means may be adapted to attach the frame to the surface such that the primary antenna substantially maintains electromagnetic coupling with the secondary antenna when the surface flexes in use or is subject to physical manipulation such as may take place during repeated washing cycles. The secondary antenna may include a pair of conductors attached to the frame.

According to a further aspect of the present invention there is provided a method of attaching an RFID tag including a primary antenna to a surface, said method including forming a tag assembly having a receptacle including a frame for securely holding the RFID tag, a secondary antenna, and attachment means for attaching the frame to said surface, wherein said frame forms part of said secondary antenna. The secondary antenna may include a dipole antenna. The surface may be flexible such as fabric or it may be relatively rigid such as cardboard.

The receptacle may include a frame for securely holding the RFID tag (AK module or QFP package) and attachment means for attaching the frame to a surface such as textile or fabric. The frame may include resiliently biased upper and lower frame portions. The upper and lower frame portions may be biased to hold the RFID tag therebetween. In one form each upper and lower frame portion may be substantially in the shape of a U. The upper and lower frame portions may be resiliently joined at the legs of each U.

In some embodiments the RFID tag may be applied to the surface in the vicinity of a structure associated with the surface which structure may function as a secondary antenna. The secondary antenna may be formed by stitching a suitable antenna pattern using conductive thread around the receptacle or casing such that the secondary antenna is flexible and relatively comfortable for a garment wearer.

The tag assembly may be adapted to be attached to a flexible material such that an associated or primary antenna substantially maintains electromagnetic coupling with the secondary antenna when the surface flexes in use or is subject to repeated physical manipulation such as may take place during washing cycles. When attaching the frame to the surface the primary antenna associated with the RFID tag held in the frame is aligned with the secondary antenna associated with the surface.

In some embodiments the secondary antenna may be attached to or formed with the receptacle or casing. The secondary antenna may include a dipole. The secondary antenna may include a pair or conductors attached to the frame. Each conductor may be substantially straight and/or preformed with a shape such as a helical shape. In one form each conductor may be formed with or attached to a leg of the U shaped frame portions such that the receptacle/frame forms part of the secondary antenna.

In an alternative method an RFID label may be provided having associated with it a secondary antenna structure for attachment to a flexible surface such as textile or fabric. The present invention may include a process for producing an RFID label. The label may be flexible. The process may include forming a label substrate and providing a secondary antenna structure in association with the substrate. The process may include fusing at least a portion of the substrate to locate an RFID tag such as an AK module or QFP package relative to the label and/or said secondary antenna structure.

According to a further aspect of the present invention there is provided a process for producing an RFID label including an RFID tag such as an AK module or QFP package, for attaching to a flexible surface such as textile or fabric, said process including forming a label substrate, providing a secondary antenna structure in association with the label substrate, attaching said RFID tag to the label substrate, folding at least a portion of the label substrate over the RFID tag and fusing the label substrate to locate an RFID tag relative to the label and/or said secondary antenna structure. The secondary antenna structure may be provided by weaving, knitting and/or stitching conductive wire in association with the label substrate.

In an alternative method the label substrate may be provided in the form of two or more separate layers or ribbons. The layers or ribbons may be joined together in a continuous reel-to-reel process by means of an adhesive, ultrasonic welding or the like.

The process may include fusing the substrate at least partly around the RFID tag to create a pocket between the folded or joined layers of label substrate. The pocket may include four spot welds around the RFID tag.

According to a further aspect of the present invention there is provided a process for producing an RFID label including an RFID tag such as an AK module or QFP package, for attaching to a flexible surface such as textile or fabric, said process including providing a label substrate including two separate layers, providing a secondary antenna structure in association with at least one layer of the label substrate, attaching said RFID tag to one layer of the label substrate, and fusing the layers of the label substrate to locate an RFID tag relative to the label and/or said secondary antenna structure. Each layer may comprise a ribbon of fabric or textile.

According to a further aspect of the present invention there is provided a process for producing an RFID label including an RFID tag, such as an AK module or QFP package, for attaching to a flexible surface such as textile or fabric, said process including forming a label substrate, providing a secondary antenna structure in association with the label substrate, forming a cavity in association with the label substrate for receiving said RFID tag, locating said RFID tag in said cavity and sealing said cavity and RFID tag with a cover.

The cover may include clear or opaque film or ribbon such as polyester. The secondary antenna structure may be provided by weaving, knitting and/or stitching conductive wire in association with the label substrate. The cavity may be formed by locally melting the label substrate. The local melting may be produced by means of a sonotrode or die head. The sonotrode or die head may be vibrated ultrasonically. The cavity may comprise a rectangular, square or round tub.

According to a further aspect of the present invention there is provided a process for attaching an RFID tag such as an AK module or QFP package to a flexible surface such as textile or fabric, said process comprising: providing a heat fusible label including at least a) a first layer having a first adhesive layer; b) a substrate layer including a secondary antenna structure; and c) a heat activated second adhesive layer; positioning said RFID tag on said flexible surface; positioning said heat fusible label on said flexible surface over said RFID tag; and applying heat and pressure to said heat fusible label to melt said heat activated layer and to fuse said label to said flexible surface.

The heat fusible label may further include a printable and waterproof upper polycarbonate sheet or layer applied over the first layer. The first layer may include a woven polymeric or synthetic material. The secondary antenna structure may be provided by weaving, knitting and/or stitching conductive wire in association with the substrate layer. The substrate layer may include a polymeric layer (PEN) or a knitted or woven layer. The RFID tag may include an AK module or QFP package.

According to a further aspect of the present invention there is provided a heat fusible RFID label assembly suitable for attachment to a flexible surface such as textile or fabric, said label comprising: a first layer including a first adhesive layer; a substrate layer including a secondary antenna structure; a heat activated second adhesive layer; and an RFID tag.

### BRIEF DESCRIPTION OF THE DRAWINGS

The present invention will be more fully appreciated with reference to the following detailed description, which in turn refers to the drawings, in which:

FIG. 1A is a front, perspective view of a basic receptacle or casing for an RFID tag;

FIG. 1B is a side, perspective view of the basic receptacle or casing for an RFID tag shown in FIG. 1A.

FIG. 2 is a side, perspective view of an RFID tag being received in the receptacle or casing of FIG. 1;

FIG. 3 is a side, perspective view of an RFID tag being retained in the receptacle or casing;

FIG. 4 is a bottom, perspective view of a backing plate associated with the receptacle or casing of FIGS. 1 to 3;

FIG. 5 is a side, perspective view of a dipole antenna associated with the receptacle or casing of FIGS. 1 to 3;

FIG. 6 is a side, perspective view of a dipole antenna associated with the receptacle or casing of FIGS. 1 to 3;

FIG. 7 is a side, perspective view of an RFID tag associated with the receptacle or casing and antenna of FIG. 6;

FIG. 8 is a side, perspective view of an alternative dipole antenna associated with the receptacle or casing of FIGS. 1 to 4;

FIG. 9 is a side, perspective view of an RFID tag being received in the receptacle or casing of FIG. 8;

FIG. 10 is a side, perspective view of an RFID tag associated with the receptacle or casing and antenna of FIG. 8;

FIG. 11 is a side, perspective view of a process for producing an RFID label;

FIG. 12 is a top, perspective view of a process for producing an RFID label;

FIG. 13 is a side, perspective view of a process for producing an RFID label;

FIG. 14A is a side, perspective view of a process for producing an RFID label;

FIG. 14B is a side, elevational view of a process for producing an RFID label;

FIG. 14C is a top, elevational view of a process for producing an RFID label;

FIG. 15 is a side perspective view of a thermosonic tool for performing welding associated with an RFID tag;

FIG. 16A is a top, elevational view of one example of a tag label that has been cut to accommodate a short antenna track;

FIG. 16B is a top, elevational view of another example of a tab label that has been cut to accommodate a medium antenna track;

FIG. 16C is a top, elevational view of another example of a tab label that has been cut to accommodate a large antenna track;

FIG. 17 is a side, perspective, exploded view of a further process for producing an RFID label;

FIG. 18 is a partial, side, elevational view of a further process for producing a RFID label;

FIG. 19 is a partial, side, exploded, elevational view of a further process for producing a RFID label;

FIG. 20 is a partial, side, exploded, elevational view of a further process for producing a RFID label;

FIG. 21 is a partial, side, exploded, elevational view of a further process for producing a RFID label;

FIG. 22 is a partial, side, exploded, elevational view of a further process for producing a RFID label;

FIG. 23 is a side, exploded, elevational view of a further process for producing an RFID label;

FIG. 24 is a partial, side, perspective, exploded view of a further process for producing an RFID label;

FIG. 25 is a top, perspective view of the details of a tape substrate being woven; and

FIG. 26 is a side, elevational, partial view of details of a conductive yarn.

### DETAILED DESCRIPTION OF THE INVENTION

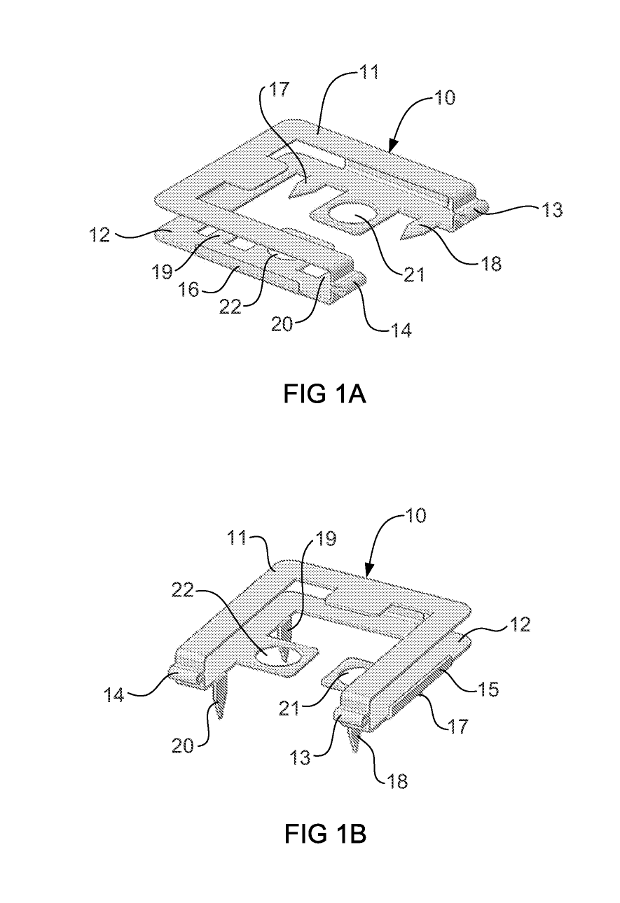

Referring to FIGS. 1A and 1B, a basic receptacle or casing for an RFID tag (such as an AK module or QFP package) comprises a frame 10 including upper frame portion 11 and lower frame portion 12. Each frame portion 11, 12 is substantially in the shape of a U. Frame portions 11, 12 are joined at the legs of each U via junctions 13, 14. Frame portions 11, 12 may be formed by die stamping from a roll or sheet of stainless steel. The junctions 13, 14 are integrally formed during the die stamping operation. Junctions 13, 14 are adapted to receive a dipole antenna as described below.

Frame 10 includes turned side portions 15, 16 formed by turning edges of lower frame portion 12. Side portions 15, 16 are adapted to at least laterally restrain an RFID tag received in the receptacle or casing. Frame 10 includes integrally formed legs 17-20 for attaching the frame to a flexible surface such as fabric. Each leg 17 to 20 is sharpened at its free end for penetrating the surface. Frame 10 includes eyelets 21, 22 suitable for attaching the receptacle or casing to a flexible surface via stitching or the like.

The frame 10 may be die stamped substantially in a flat configuration as shown in FIG. 5 with integral frame portions 11, 12, junctions 13, 14, side portions 15, 16, legs 17 to 20 and eyelets 21, 22. Frame portions 11, 12 may subsequently be turned towards each other to form the clip configuration shown in FIGS. 1 to 3 and 6 to 10.

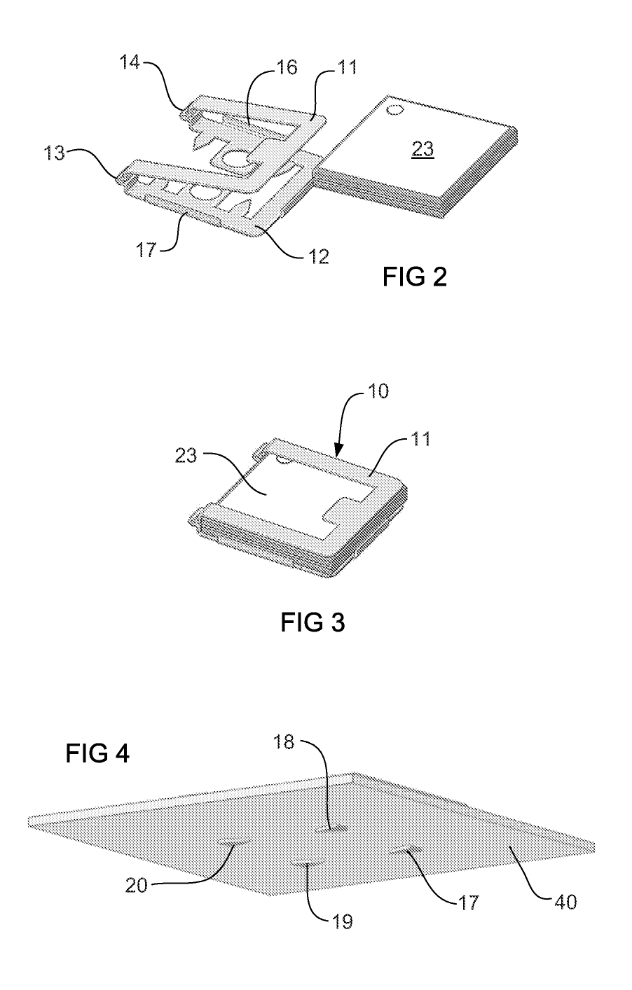

FIG. 2 shows an RFID tag 23 being received in frame 10. RFID tag 23 may include a separately formed adaptive kernel (AK) module (UHF tag) manufactured by Tagsys SAS. The AK module is conveniently provided in the form of a quad flat pack (QFP) kernel. Frame portion 11 may be forced open from the rest position shown in FIG. 1 relative to frame portion 12 against a resilient restoring force provided via junctions 13, 14. Following insertion of tag 23, the restoring forces returns frame portion 11 to its rest position to securely hold tag 23 between frame portions 11, 12, as shown in FIG. 3.

FIG. 4 shows a backing plate 40 including apertures for receiving legs 17 to 20 associated with the receptacle or casing of FIGS. 1 to 3. Backing plate 40 may be formed from any suitable material such as plastics. Backing plate 40 may be positioned on the underside of a flexible surface such as fabric or textile. Following attachment of the receptacle or casing to a surface, legs 17 to 20 may be passed through the apertures of backing plate 40 and turned approximately 90 degrees as shown in FIG. 4 to secure the receptacle or casing to the flexible surface.

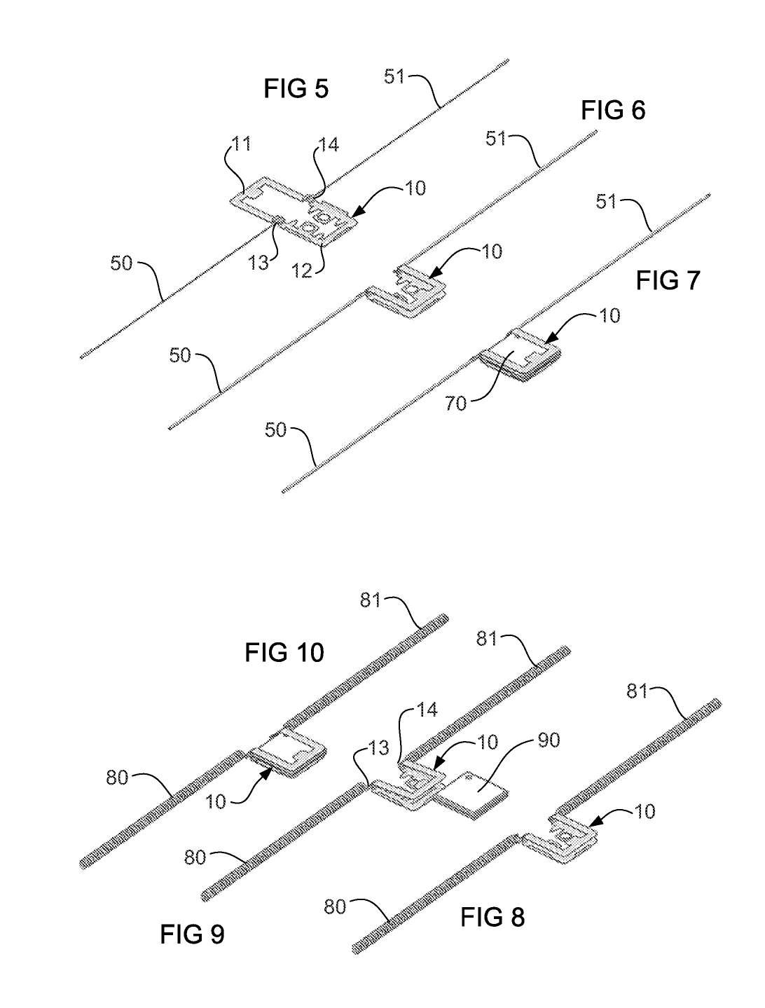

FIG. 5 shows a pair of substantially straight conductors 50, 51 electrically welded to frame 10 to form a dipole antenna. Conductors 50, 51 may be adapted to make a long dipole antenna if required. Conductors 50, 51 are welded to frame 10 at junctions 13, 14 respectively. Welding of conductors 50, 51 may be performed after stamping of frame 10. Following welding, frame portions 11, 12 are subsequently turned towards each other to form a tag assembly as shown in FIG. 6. FIG. 7 shows an RFID tag 70 in association with the tag assembly of FIG. 6 suitable for attachment to a flexible surface or the like.

FIG. 8 shows a pair of preformed helical conductors 80, 81 electrically welded to frame 10 to form a dipole antenna. Conductors 80, 81 are welded to frame 10 at junctions 13, 14 respectively. The welding may be performed after stamping of frame 10. Following welding frame portions 11, 12 may subsequently be turned towards each other to form a tag assembly as shown in FIG. 8. FIG. 9 shows an RFID tag 90 being inserted into the tag assembly of FIG. 8. Helical conductors 80, 81 may be adjusted in length to suit tag 90 by stretching. FIG. 10 shows RFID tag 90 in association with the tag assembly of FIG. 8 suitable for attachment to a flexible surface or the like.

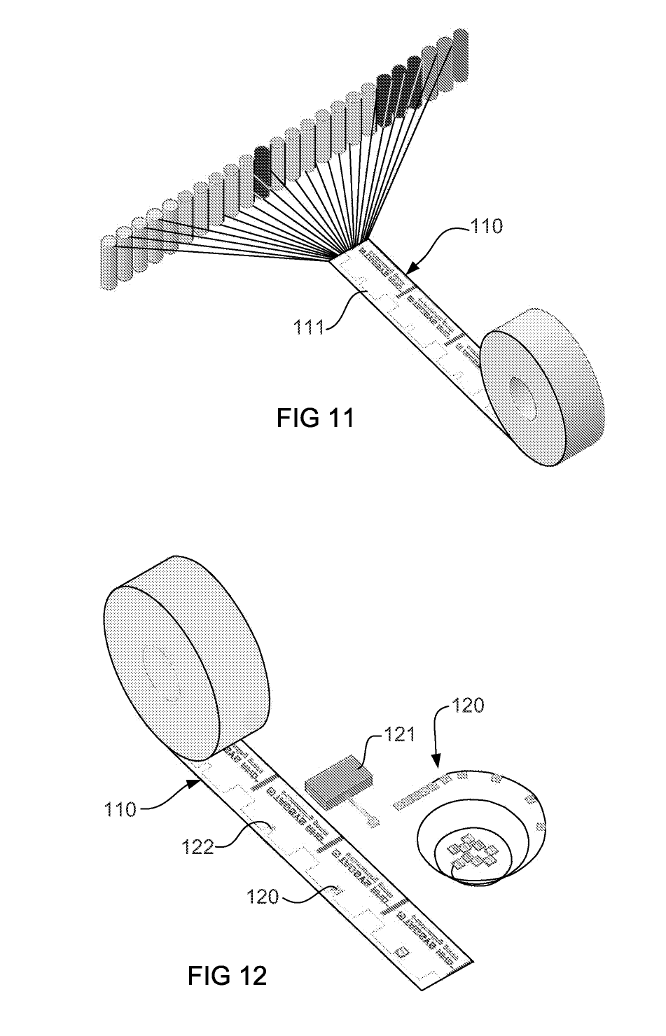

FIG. 11 shows tape substrate 110 being woven or knitted on a loom (not shown). Tape substrate 110 comprises a plurality of yarns including synthetic yarns such as polyester nylon, polyamide and carbon and conductive yarns such as stainless steel suitable for industrial washing liquids. The conductive yarns may be woven, knitted and/or stitched in association with tape substrate 110 to form an antenna pattern 111. The antenna pattern 111 may form plural separate antennas after tape substrate 110 is singulated into individual labels. Each label may be attached to an article such as an item of clothing. The tape substrate may include a printed logo. The logo may be laser printed onto the singulated label during assembly or it may be printed onto a reel of tape substrate before assembly.

FIG. 12 shows a production line process for attaching RFID tags 120 to tape substrate 110 such as by means of a multi-step online machine. The process includes supplying individual tags 120 via a bowl feeder or the like and testing and programming each tag 120 at a testing station 121 prior to attaching the tags 120 to tape substrate 110. Each tag 120 is attached to tape substrate 110 via a layer of adhesive 122 applied to tape substrate 110. This is followed by accurate positioning of each tag 120 relative to antenna pattern 111 to ensure good electromagnetic coupling to a primary antenna associated with tag 120.

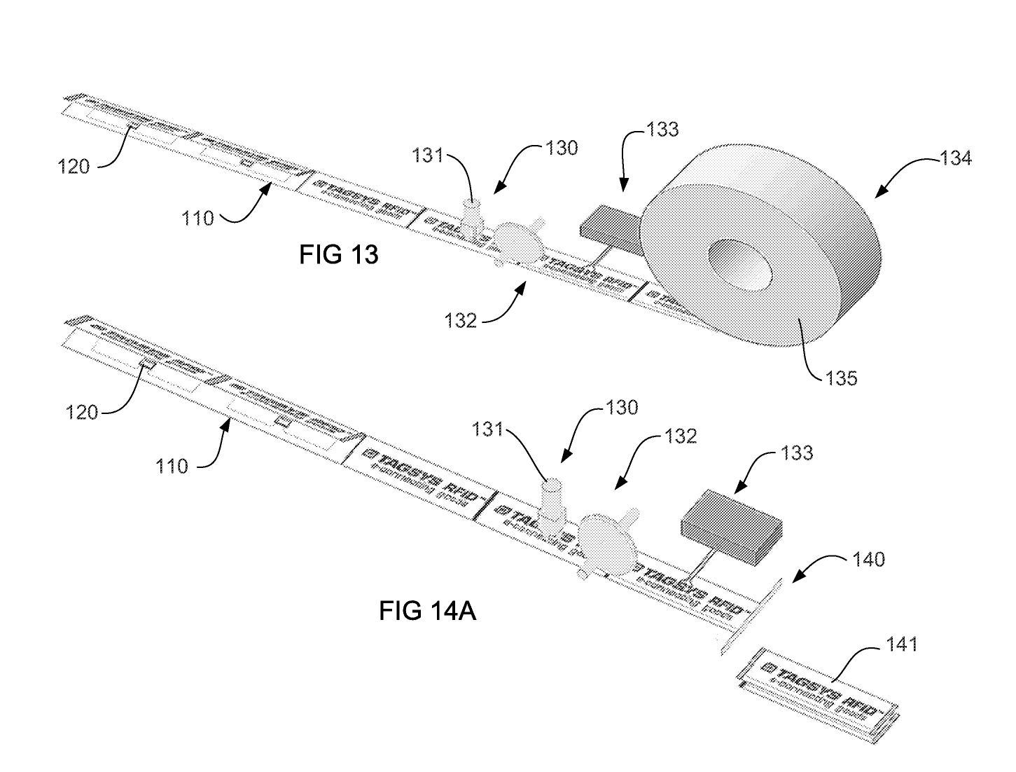

FIG. 13 shows a fusing station 130 which follows a tape folding station (not shown) for folding tape substrate 110 in half over tags 120. Fusing station 130 includes fusing tool 131 including four sonotrodes (raised portions). The sonotrodes cooperate with an anvil (not shown) to make four spot welds around RFID tag 120. The four spot welds create a pocket between the folded layers of tape substrate 110 for locating RFID tag 120 in the pocket. FIG. 13 includes an ultrasonic welding station 132 for continuously sealing the open seam comprising folded layers of tape substrate 110. This is followed by testing of each label with tag 120 at testing station 133. Labels that do not pass the test may be marked with a black dot or punched with a hole for identification. FIG. 13 includes a winding station 134 for winding the tested labels onto roll 135 suitable for subsequent automatic deposition of labels.

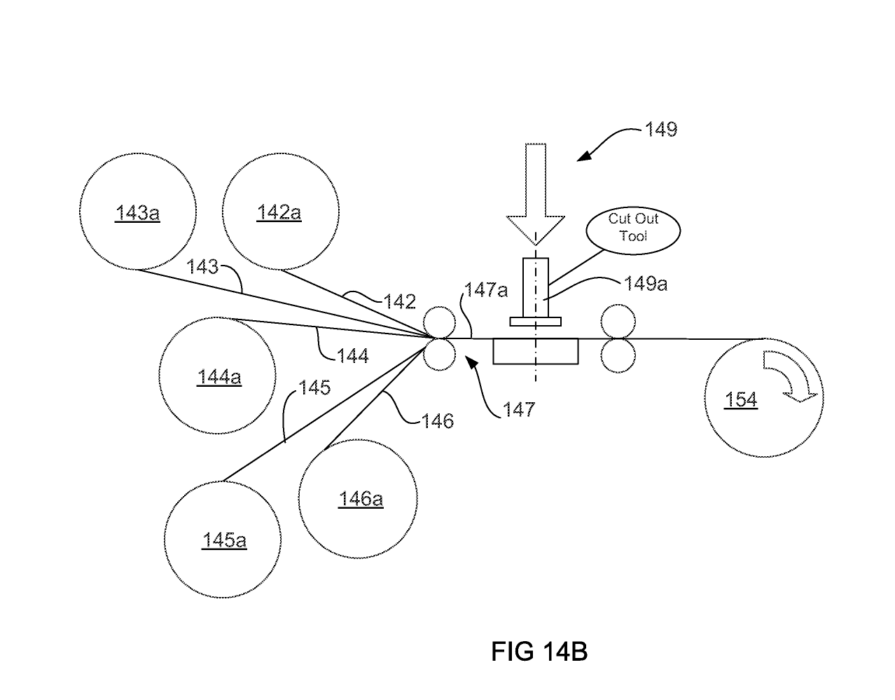

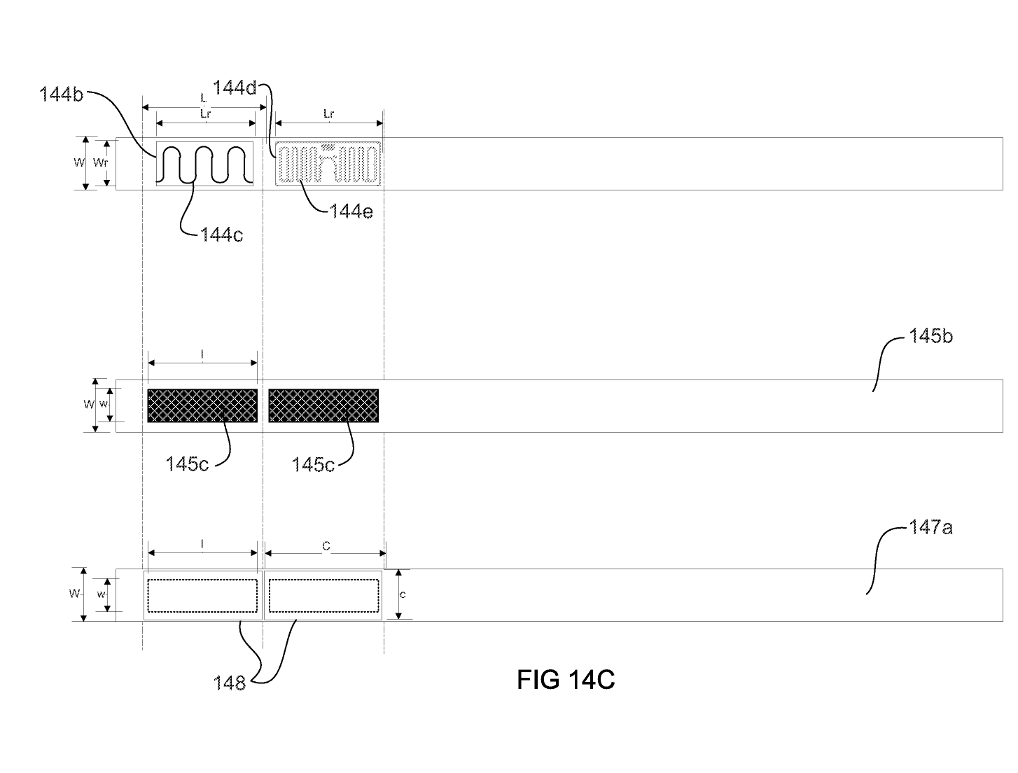

FIG. 14A shows a modification of the process shown in FIG. 13 including singulation station 140 for cutting tape substrate 110 into individual labels 141. The modified process in FIG. 14 is suitable for manual deposition of individual labels 141.

An alternative method is described below with reference to FIGS. 14B and 14C. In the alternative method the label substrate 110 may be produced from a plurality of separate layers 142-146. The layers 142-146 may be supplied in the form of tapes or ribbons from respective input reels 142a-146a. Layer 142 includes a printable protective polymeric overlay. Layer 143 includes an adhesive. Layer 144 includes a woven substrate (fabric or textile) 144b with conductive thread woven therein to provide a secondary antenna inlay 144c. Alternatively layer 144 may include a polymeric or synthetic substrate (PEN) 144d with an etched copper or aluminium track to provide the secondary antenna inlay 144e. Layer 145 includes a silicon liner 145b with preformed islands of heat activated adhesive 145c.

Layer 146 includes a silicon impregnated paper carrier or the like. Layers 142-146 may be joined together by means of pressing rollers 147 to cold laminate the separate layers into a composite label assembly 147a. The composite assembly may be pre-cut into separate labels 148 at a cutting station 149 via a cutting tool 149a. The finished product is wound onto output reel 154.

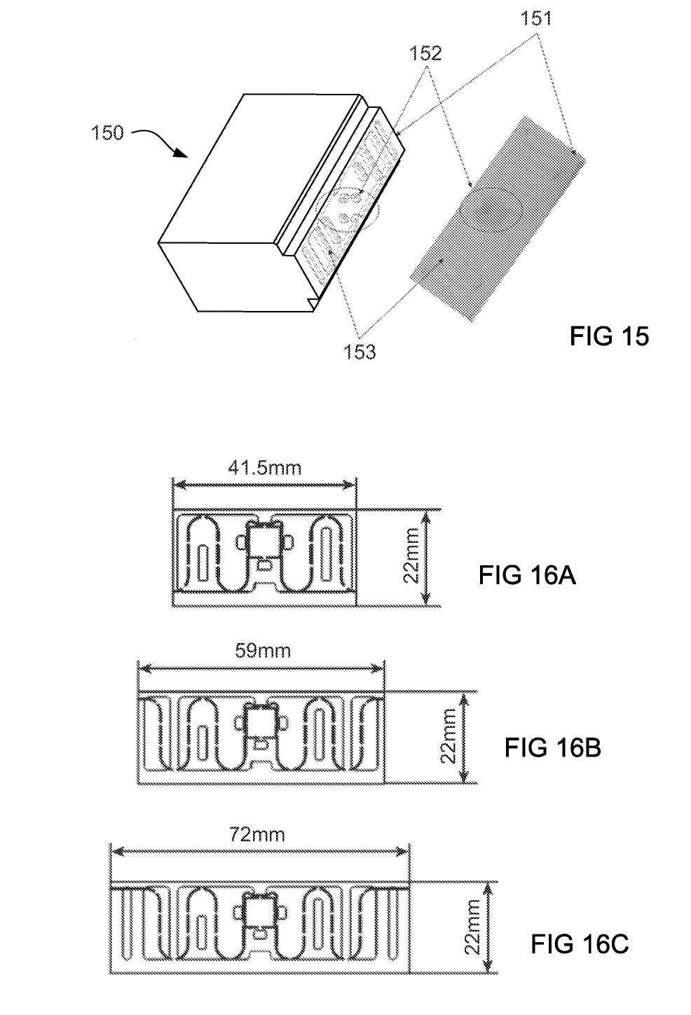

FIG. 15 shows a welding tool 150 including a peripheral sonotrode 151 for fusing together upper and lower tapes or ribbons such as the folded layers of tape substrate 110 shown in FIGS. 13 and 14a. Welding tool 150 may be used in place of fusing tool 131 described above in connection with FIG. 13. Welding tool 150 also includes four spot sonotrodes 152 adapted to make four spot welds around RFID tag 120 similar to fusing tool 131 to create a pocket between the upper and lower tapes or ribbons for locating RFID tag 120 in the pocket. Welding tool 150 also includes partition sonotrodes 153 adapted to partition a label to accommodate short (42 mm), medium (59 mm) or long (72 mm) antenna tracks respectively. Examples of label 141 that has been cut to accommodate short, medium and long antenna tracks are shown in FIGS. 16A, 16B and 16C respectively.

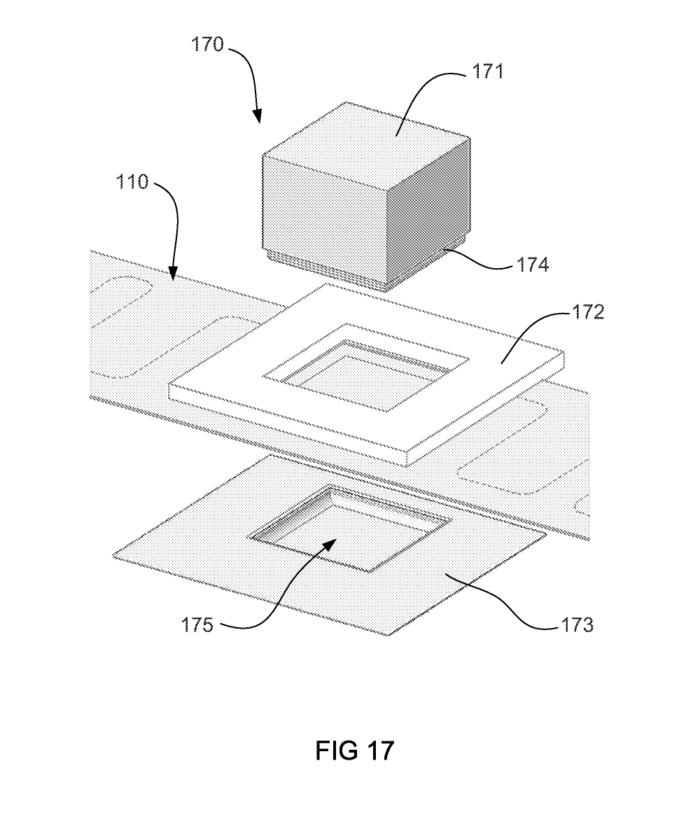

FIGS. 17 to 22 show a modification to the production line process in FIGS. 12 to 14. FIG. 17 includes cavity forming station 170 for forming a tub cavity in tape substrate 110. The tub cavity may be adapted to receive an RFID tag. The tub cavity may be approximately 1-2 mm deep and dimensioned to receive the RFID tag. Cavity forming station 170 includes sonotrode or die head 171, clamp 172 and matrix 173 (anvil). Die head 171 includes base 174 adapted to form a rectangular cavity in tape substrate 110. Matrix 173 includes cavity 175 in a shape of a rectangular tub for receiving base 174 of die head 171. Clamp 172 is adapted to hold tape substrate 110 against matrix 173 during a cavity forming operation. During the cavity forming operation, base 174 of die head 171 is vibrated ultrasonically (e.g. at 40-60 KHz) and pressed against tape substrate 110, causing tape substrate 110 to heat and deform locally against cavity 175 in matrix 173. Ultrasonic vibration may be provided by means of a piezoelectric transducer or the like. In some versions die head 171 and matrix 173 may be adapted to form a round instead of a rectangular cavity.

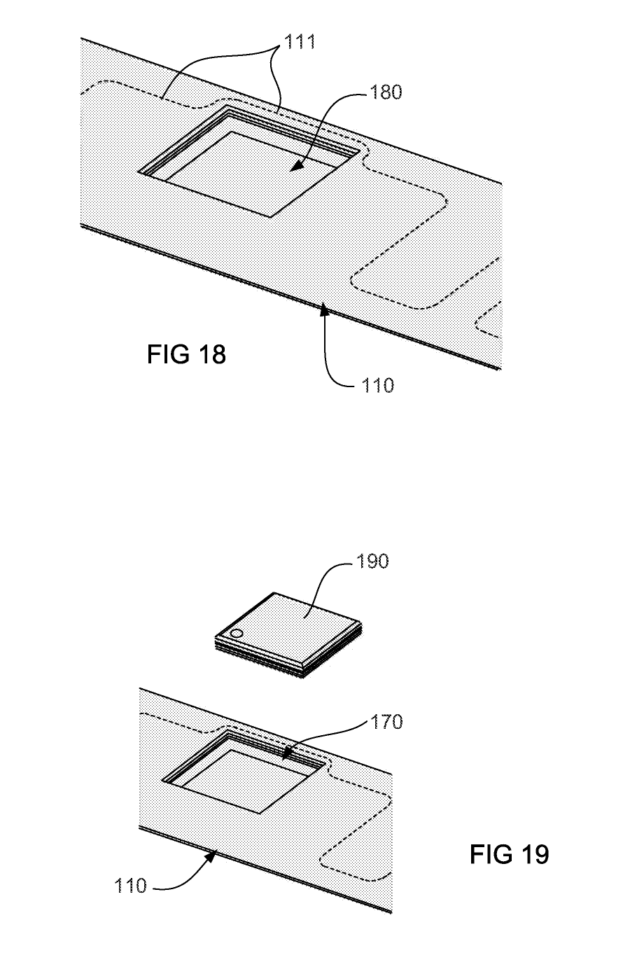

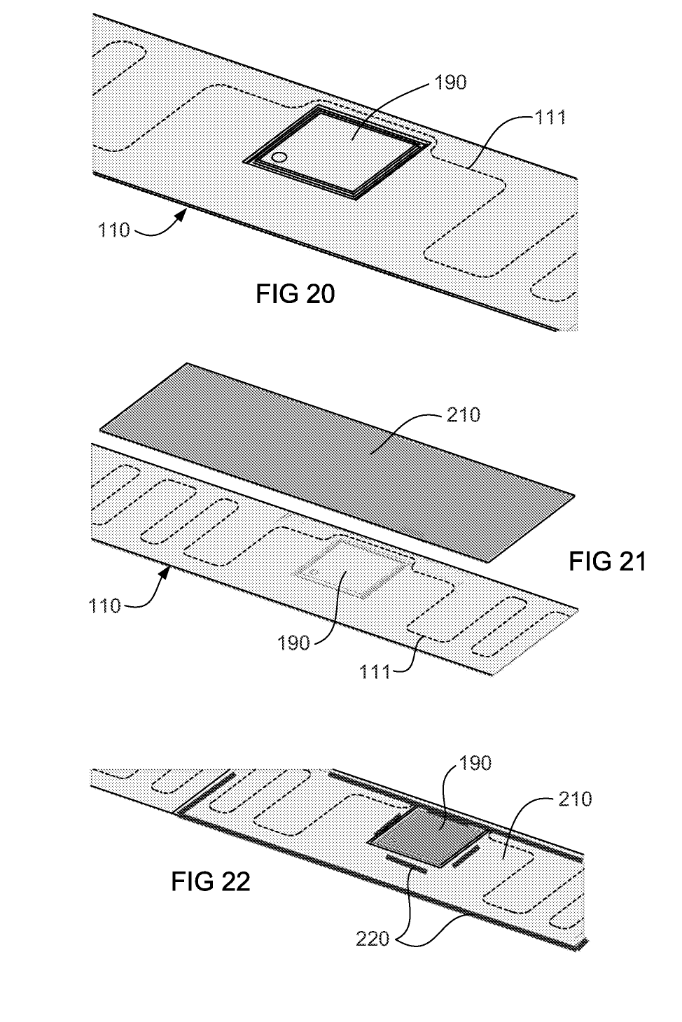

FIG. 18 shows a view of tape substrate 110 including cavity 180 formed with an antenna pattern 111 passing around cavity 180. FIG. 19 shows RFID tag 190 after testing positioned above cavity 180 in tape substrate 110 and before being dropped into cavity 180. FIG. 20 shows RFID tag 190 after it is dropped into cavity 180 in tape substrate 110. FIG. 21 shows a polyester film cover 210 comprising clear or opaque ribbon positioned over tape substrate 110 and RFID tag 190 in cavity 180. Film cover 210 may be ultrasonically welded to tape substrate 110 via seams 220 as shown in FIG. 22.

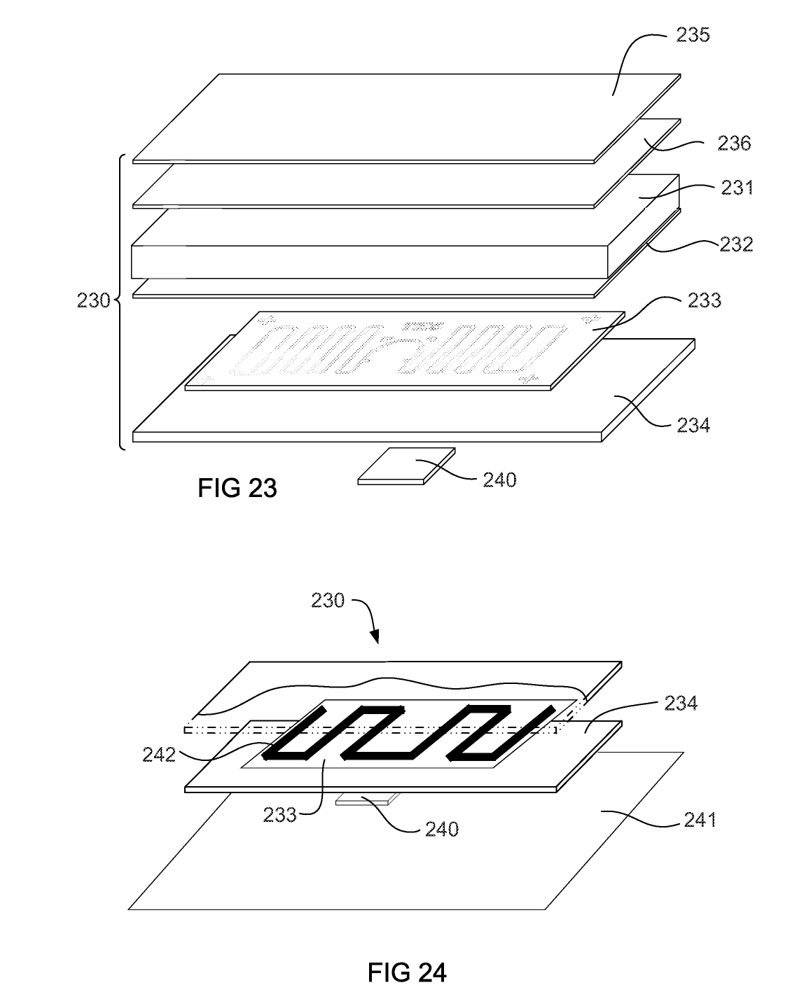

An alternative tag assembly method that does not require a tape substrate or cavity is described below with reference to FIGS. 23 and 24. FIG. 23 shows a thermo patch assembly 230 comprising at least the following layers:

1. a top woven polymeric sheet or synthetic layer 231;

2. an adhesive layer 232 for a secondary antenna layer;

3. a secondary antenna layer 233; and

4. a heat activated adhesive layer 234 such as a polyurethane adhesive layer.

Secondary antenna layer 233 may be provided on a woven (textile or fabric) or plastics (PEN) substrate. An optional overlayer 235 such as polycarbonate sheet and a polyurethane primer layer 236 may be applied over top layer 231 to make the patch assembly 230 printable and/or waterproof. The thermo patch assembly 230 may be used to apply an RFID tag 240 to a garment or fabric as shown in FIG. 24.

In FIG. 24 an RFID tag 240 is sandwiched between a flexible surface 241 such as fabric, textile or a garment and an opaque and printable thermo patch 230. As described above, thermo patch 230 includes a layer of heat activated adhesive 234 on its underside adapted to hold antenna layer 233. Antenna layer 233 comprises a polymeric substrate such as polyethylene napthalate (PEN) with an antenna pattern 242 applied thereto. Antenna pattern 242 comprises a conductor such as copper or aluminium. Heat activated adhesive 234 is interposed between layer 233 and surface 241 for heat sealing patch 230 to hold antenna layer 233 and RFID tag 240 in position against surface 241. Each tag 240 should be placed accurately relative to antenna pattern 242 to ensure good electromagnetic coupling to a primary antenna associated with tag 240.

The method of attaching thermo patch 230 to surface 241 may be performed manually using heat sealing equipment set at around 180-200° C. to press and activate the adhesive. The patch assembly may then be resistant to washers and driers. The process may use a conventional etched aluminium or copper conductive antenna on a PEN substrate (the latter may withstand higher temperatures than PET) which is adhered to a thermo sealing patch. Printable patches 230 with secondary antenna already attached and covered with heat activated adhesive such as hot melt glue may be supplied to an operator ready for attachment to garment/fabric surface 241 or the like.

The operator may initially place RFID tag 240 (QFP/TQFP) on top of garment/fabric surface 241, and then cover it with a thermo patch 230 including secondary antenna layer 233 and pattern 242. Thermal sealing equipment may then be used to press and heat thermo patch 230 on top of garment/fabric surface 241 causing thermo patch 230 and RFID tag 240 to be attached to garment/fabric surface 241.

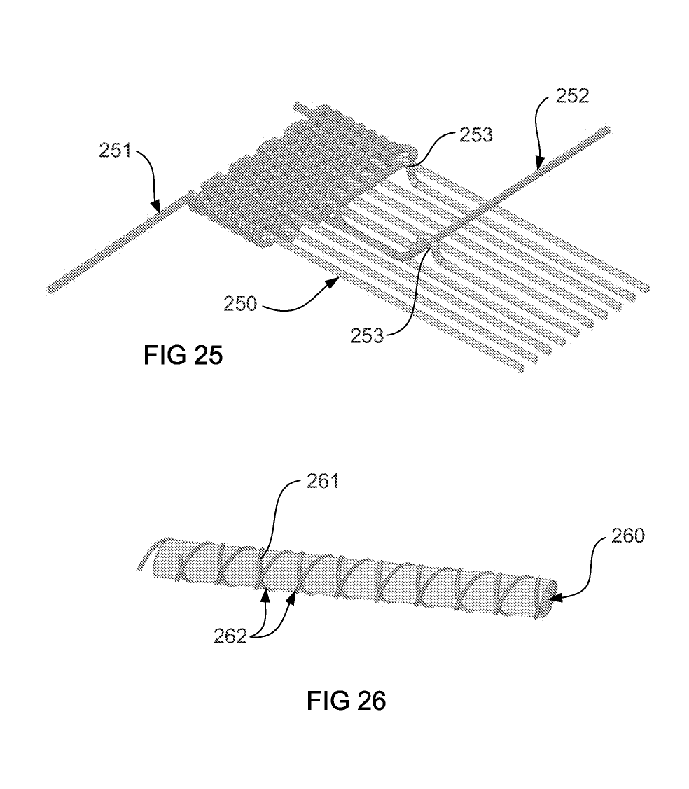

FIG. 25 shows a tape substrate such as tape substrate 110 in FIG. 11, being woven on a loom (not shown). Tape substrate 110 includes a plurality of warp yarns 250 stretched on a loom and weft yarns 251 being drawn through the warp yarns 250. Tape substrate 110 includes a conductive yarn 252 drawn through loops 253 in warp yarns 250 to create a secondary antenna pattern such as antenna pattern 111 in FIG. 11.

FIG. 26 shows an example of conductive yarn 252 including a bundle of stainless steel filaments or wires 260. Each stainless steel filament or wire in bundle 260 may be a few hundred μm in diameter. Each bundle 260 may include a few tens of stainless steel filaments or wires wrapped with synthetic threads or filaments 261 such as polyamide or polyester, to form a synthetic sheath 262. To maintain the stainless steel filaments bundled together, they are shown double wrapped clockwise and anti-clockwise with the synthetic threads or filaments 261. As well as keeping the stainless steel filaments bundled together the synthetic sheath 262 helps to reduce damage to synthetic yarns of tape substrate 110 due to cutting that may be caused by the edges of the stainless steel filaments as the latter is woven into tape substrate 110.

Finally, it is to be understood that various alterations, modifications and/or additions may be introduced into the constructions and arrangements of parts previously described without departing from the spirit or ambit of the invention.

1. A tag assembly for attaching an RFID tag including a primary antenna to a surface, said assembly having a receptacle including a frame for securely holding the RFID tag, a secondary antenna, and attachment means for attaching the frame to said surface wherein said frame forms part of said secondary antenna.

2. A tag assembly according to claim 1, wherein said surface is flexible.

3. A tag assembly according to claim 1, wherein said secondary antenna includes a dipole antenna.

4. A tag assembly according to claim 1, wherein said frame is formed with a plurality of like frames by die stamping from a roll of conductive material.

5. A tag assembly according to claim 4, wherein said conductive material includes stainless steel.

6. A tag assembly according to claim 1, wherein said attachment means includes a plurality of legs including a free end connected to said frame and wherein the free end of each of said plurality of legs includes a sharpened lead to penetrate said surface.

7. (canceled)

8. A tag assembly according to claim 6, including a backing plate for receiving the plurality of legs.

9. A tag assembly according to claim 8, wherein said backing plate includes apertures to accommodate said legs.

10. A tag assembly according to claim 1, wherein said assembly includes said RFID tag.

11. A tag assembly according to claim 1, wherein said surface includes fabric, textile or an item of clothing.

12. A tag assembly according to claim 1, wherein said attachment means is adapted to attach said frame to said surface such that said primary antenna substantially maintains electromagnetic coupling with said secondary antenna when said surface flexes in use or is subject to repeated physical manipulation such as may take place during washing cycles.

13. A tag assembly according to claim 1, wherein said secondary antenna includes a pair or conductors attached to said frame.

14. A method of attaching an RFID tag including a primary antenna to a surface, said method including forming a tag assembly having a receptacle including a frame for securely holding the RFID tag, a secondary antenna, and attachment means for attaching the frame to said surface, wherein said frame forms part of said secondary antenna.

15. A method according to claim 14, wherein said surface is flexible.

16. A method according to claim 14, wherein said secondary antenna includes a dipole antenna.

17. A method according to claim 13, including forming said frame with a plurality of like frames by die stamping from a roll of conductive material.

18. A method according to claim 17, wherein said conductive material includes stainless steel.

19. A method according to claim 14, including forming the attachment means as a plurality of legs including a free end connected to said frame, and including forming the free end of each of said plurality of legs with a sharpened lead to penetrate said material.

20. (canceled)

21. A method according to claim 14, wherein said RFID tag is provided in association with said frame.

22. A process for producing an RFID label including an RFID tag such as an AK module or QFP package, for attaching to a flexible surface such as textile or fabric, said process including forming a label substrate, providing a secondary antenna structure in association with the label substrate, attaching said RFID tag to the label substrate, folding at least a portion of the label substrate over the RFID tag and fusing the label substrate to locate an RFID tag relative to said secondary antenna structure.

23. A process for producing a RFID label according to claim 22, wherein said secondary antenna structure is provided by weaving, knitting and/or stitching conductive wire in association with said label substrate.

24. A process for producing a RFID label according to claim 22, including fusing said substrate at least partly around said RFID tag to create a pocket between the folded layers of label substrate.

25. A process for producing a RFID label according to claim 24, wherein said pocket includes four spot welds around said RFID tag.

26. A process for producing an RFID label including an RFID tag such as an AK module or QFP package, for attaching to a flexible surface such as textile or fabric, said process including providing a label substrate including two separate layers, providing a secondary antenna structure in association with at least one layer of the label substrate, attaching said RFID tag to one layer of the label substrate, and fusing the layers of the label substrate to locate an RFID tag relative to the label and/or said secondary antenna structure.

27. A process according to claim 26, wherein each layer comprises a ribbon of fabric or textile.

28. A process for producing a RFID label according to claim 26, wherein said secondary antenna structures is provided by weaving, knitting and/or stitching conductive wire in association with said label substrate.

29. A process for producing a RFID label according to claim 26, including fusing said substrate at least partly around said RFID tag to create a pocket between the folded or layers of label substrate.

30. A process for producing a RFID label according to claim 29, wherein said pocket includes four spot welds around said RFID tag.

31. A process for producing an RFID label including an RFID tag, such as an AK module or QFP package, for attaching to a flexible surface such as textile or fabric, said process including forming a label substrate, providing a secondary antenna structure in association with the label substrate, forming a cavity in association with the label substrate for receiving said RFID tag, locating said RFID tag in said cavity and sealing said cavity and RFID tag with a cover.

32. A process for producing a RFID label according to claim 31, wherein said cover includes clear or opaque film or ribbon.

33. A process for producing a RFID label according to claim 30, wherein said secondary antenna structure is provided by weaving, knitting and/or stitching conductive wire in association with said label substrate.

34. A process for producing a RFID label according to claim 31, wherein said cavity is formed by locally melting said label substrate.

35. A process for producing a RFID label according to claim 31, wherein said cavity is formed by means of a sonotrode or die head.

36. A process for producing a RFID label according to claim 35, wherein said sonotrode or die head is vibrated ultrasonically.

37. A process for producing a RFID label according to claim 32, wherein said cavity comprises a rectangular, square or round tub.

38. A process for attaching an RFID tag such as an AK module or QFP package to a flexible surface such as textile or fabric, said process comprising:
providing a heat fusible label including at least a) a first layer having a first adhesive layer; b) a substrate layer including a secondary antenna structure; and c) a heat activated second adhesive layer;
positioning said RFID tag on said flexible surface;
positioning said heat fusible label on said flexible surface over said RFID tag; and
applying heat and pressure to said heat fusible label to melt said heat activated layer and to fuse said label to said flexible surface.

39. A process for attaching an RFID tag according to claim 38, wherein said heat fusible label further includes a printable and waterproof upper polycarbonate sheet or layer applied over said first layer.

40. A process for attaching an RFID tag according to claim 38, wherein said first layer includes a woven polymeric or synthetic material.

41. A process for attaching an RFID tag according to claim 38, wherein said secondary antenna structure is provided by weaving, knitting and/or stitching conductive wire in association with said substrate layer.

42. A process for attaching an RFID tag according to claim 38, wherein said substrate layer includes a polymeric layer (PEN) or a knitted or woven layer.

43. A process for attaching an RFID tag according to claim 38, wherein said RFID tag includes an AK module or QFP package.

44. A heat fusible RFID label assembly suitable for attachment to a flexible surface such as textile or fabric, said label comprising:
a first layer including a first adhesive layer;
a substrate layer including a secondary antenna structure;
a heat activated second adhesive layer; and
an RFID tag.

45. A heat fusible RFID label assembly according to claim 44, further including a printable and waterproof upper polycarbonate sheet or layer applied over said first layer.

46. A heat fusible RFID label assembly according to claim 44, wherein said first layer includes a woven polymeric or synthetic material.

47. A heat fusible RFID label assembly according to claim 44, wherein said secondary antenna structure is provided by weaving, knitting and/or stitching conductive wire in association with said substrate layer.

48. A heat fusible RFID label assembly according to claim 44, wherein said substrate layer includes a polymeric layer (PEN) or a knitted or woven layer.

49. A heat fusible RFID label assembly according to claim 44, wherein said RFID tag includes an AK module or QFP package.

50-51. (canceled)
